(19) United States
(12) Patent Application Publication
(10) Pub. No.: US 2002/0069478 A1
(43) Pub. Date: Jun. 13, 2002

(54) Easily assembled castor wheel for chairs, armchairs and the like

(76) Inventor: Ruggero Trivini, S. Angelo Lodigiano (LODI) (IT)

Correspondence Address: James V. Costigan, Esq., HEDMAN & COSTIGAN, P.C., Suite 2003, 1185 Avenue of the Americas, New York, NY, 10036-2646, US

(21) Appl. No.: 10/004,631

(22) Filed: Dec. 4, 2001

(30) Foreign Application Priority Data
Dec. 12, 2000 (IT) MI2000U 000695

(51) Int. Cl. B60B 33/00

(52) U.S. Cl. 16/35 R

(57) ABSTRACT

An easily assembled castor wheel for chairs, armchairs and the like, comprises a supporting body defining a seat for housing a vertical pivot pin for coupling the wheel to the chair, and being supported by a pair of adjoining arranged wheels, the main feature of the invention is that the wheels comprise removable front cover elements.

### BACKGROUND OF THE INVENTION

The present invention relates to an easily assembled castor wheel, specifically designed for chairs, armchairs and the like.

As is known, conventional castor wheels used for chairs, armchairs or the like, comprise a supporting body defining a seat for housing herein a vertical pivot pin for coupling to a chair body or the like.

The supporting body comprises a horizontally extending pin, on which are coupled a pair of wheel members, arranged in an adjoining opposite relationship.

Each wheel element comprises a central body, having a hub for providing a forced connection to a horizontal shaft and including a peripheral edging defining the rolling surface of the wheel.

In conventional castor wheels, said wheels, as made, have a given color, which cannot be modified after the construction of the wheels.

This requires the provision of a large storing space for storing different colored castor wheels, which are required by the user for fitting a lot of different colors chairs on which said wheels must be assembled.

### SUMMARY OF THE INVENTION

Accordingly, the aim of the present invention is to overcome the above mentioned drawback, by providing an easily assembled castor wheel, specifically designed for chairs, armchairs and the like, allowing to modify the color of the front portion of the wheel, and this by providing a covering element which can be simply applied to the wheel after the assembling thereof.

Within the scope of the above mentioned aim, a main object of the present invention is to provide such a castor wheel allowing a user to define the color of the front portion of the wheel, without using assembling tools, for assembling the components of the castor wheel.

Another object of the present invention, is to provide a castor wheel which, owing to its specifically designed constructional feature, is very reliable and safe in operation.

Yet another object of the present invention is to provide such a castor wheel which is very competitive from a mere economic standpoint.

According to one aspect of the present invention, the above mentioned aim and objects, as well as yet other objects, which will become more apparent hereinafter, are achieved by an easily assembled castor wheel, specifically designed for chairs, armchairs and the like, comprising a supporting body defining a seat for housing a vertical pin for coupling said castor wheel to a chair, and supporting a pair of adjoining wheel elements, characterized in that said castor wheel comprises front covering means removably coupled to said wheel elements.

### BRIEF DESCRIPTION OF THE DRAWINGS

Further characteristics and advantages of the present invention will become more apparent hereinafter from the following detailed disclosure of an easily assembled castor wheel, specifically designed for chairs, armchairs and the like, and being shown, by way of an indicative, but not limitative, example, in the accompanying drawings, where:

FIG. 1 is a side view of the castor wheel according to the present invention;

FIG. 2 is a front view of the castor wheel according to the invention;

FIG. 3 shows the castor wheel according to the invention in a locked condition thereof;

FIG. 4 shows the castor wheel according to the invention in an unlocked condition thereof;

FIG. 5 is an exploded cross-sectional view illustrating the castor wheel according to the invention; and

FIG. 6 illustrates a cross-sectional view of the castor wheel in an assembled condition thereof.

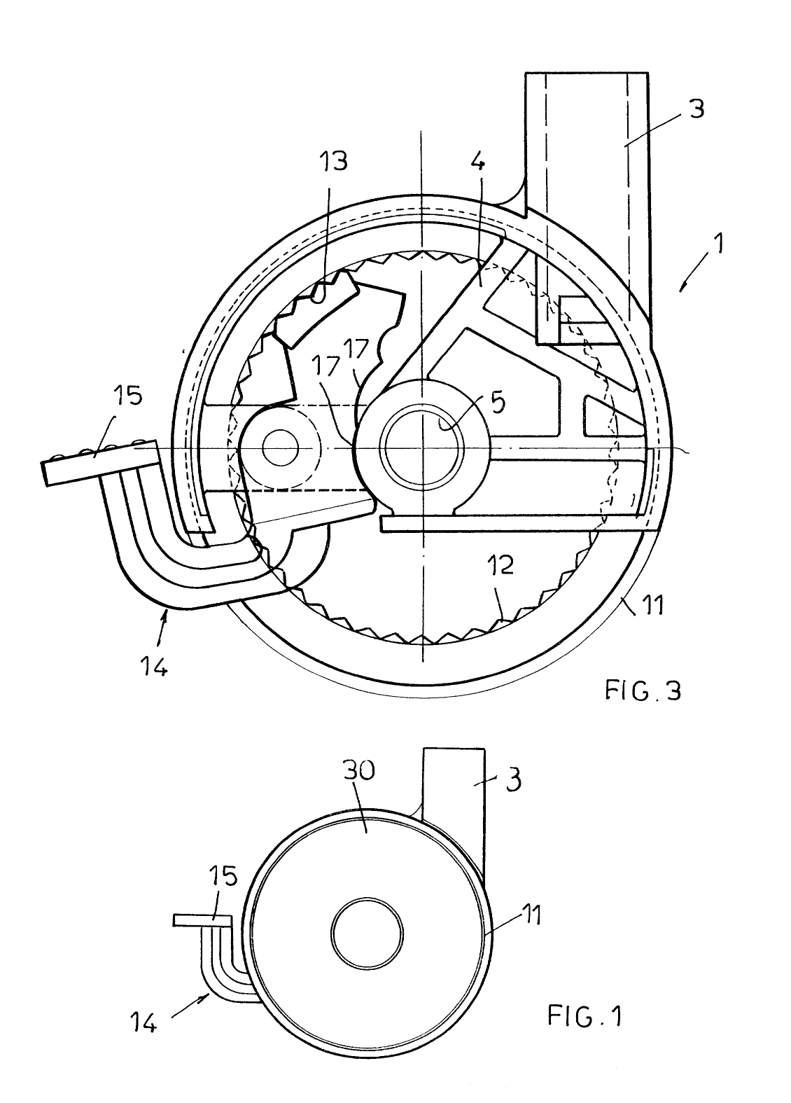

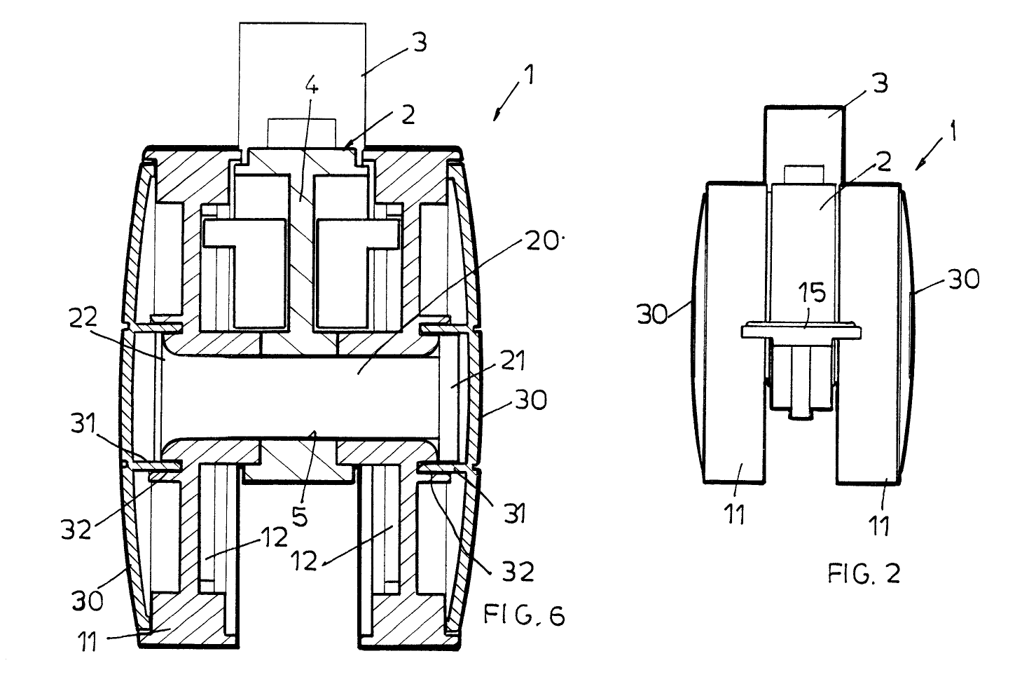

### DESCRIPTION OF THE PREFERRED EMBODIMENTS

With reference to the number references of the above mentioned figures, the easily assembled castor wheel, specifically designed for chairs, armchairs and the like, which has been generally indicated by the reference number 1, comprises a supporting body 2, defining a seat 3 in which is housed a vertical coupling pin for coupling said castor wheel to a chair or the like.

The supporting body 2 defines a central portion 4, in which is made a horizontal hole 5 for supporting a pin 10, which will be disclosed in a more detailed manner hereinafter, and which constitutes the rotary axis for a pair of wheel elements 11, which are arranged in an adjoining opposite relationship with respect to the central portion.

The wheel elements 11 comprise an inner gear ring 12, therewith engages the tooth pattern 13 of a locking element 14 swingably mounted on the body 2 and including an outward accessible pedal portion 15.

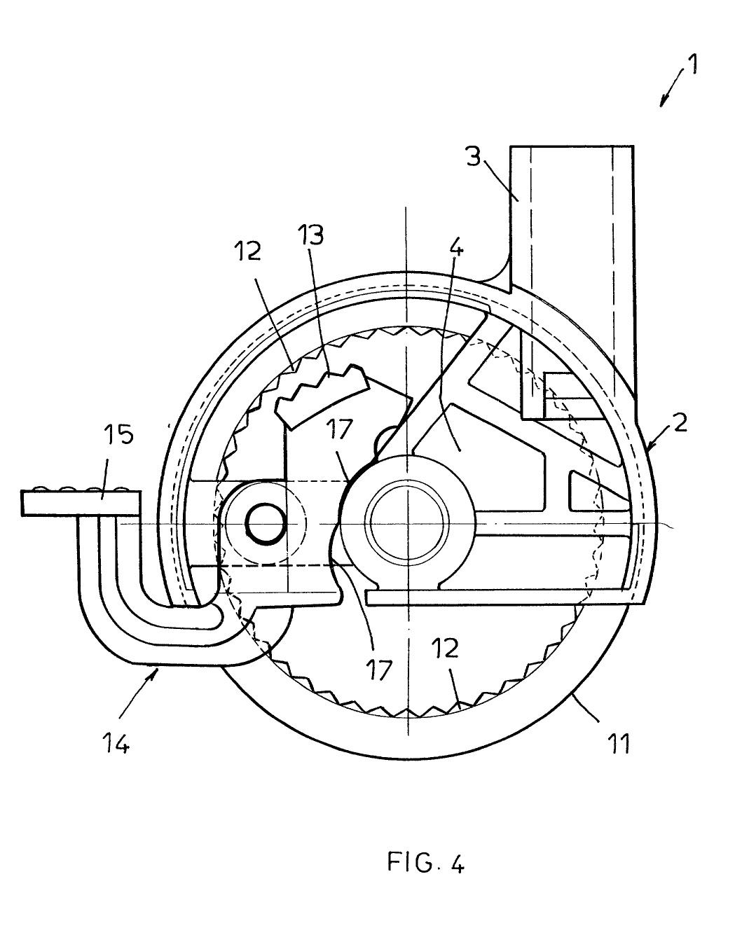

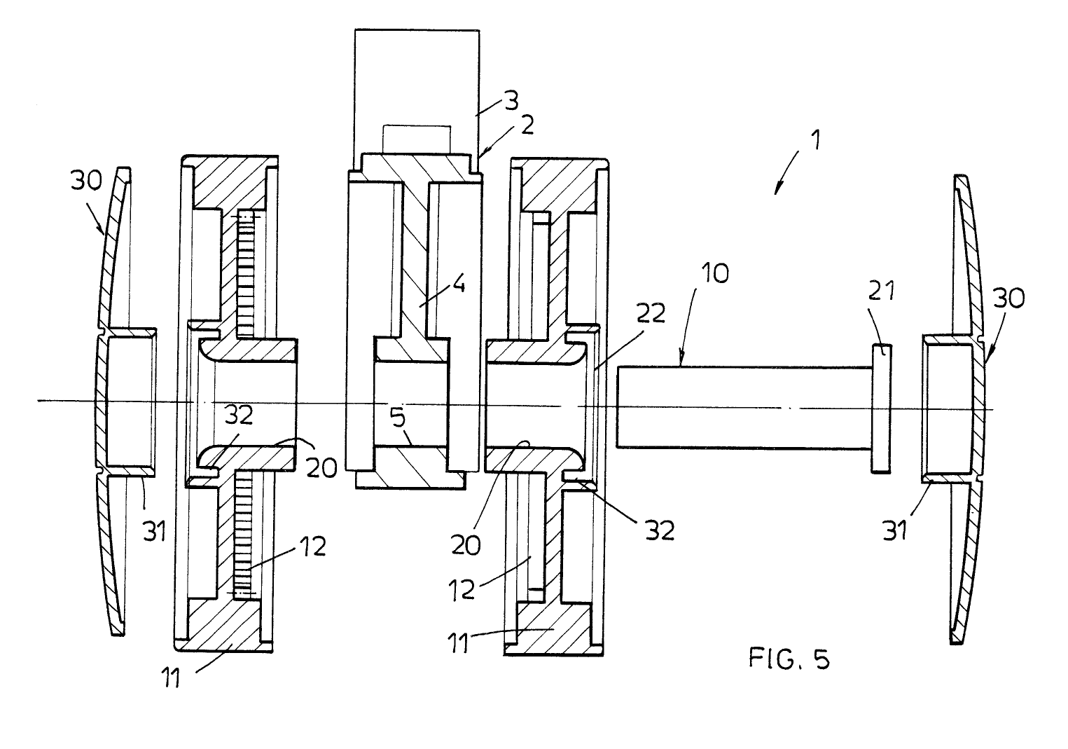

Said locking element 14 allows to arrange the locking tooth pattern 13 at an engagement position, as is clearly shown in FIG. 3, and at a disengagement position, as is clearly shown in FIG. 4.

To that end, recesses 17 for arranging the locking element 14 at a pair of stable positions are herein provided.

The main feature of the present invention is that the pin 10 is engaged in bush seats 20 defined on the wheel elements, which are axially restrained since the pin 10 comprises, at one end portion thereof, an enlarged pin head 21 axially engaging with a bush and, at the other end portion thereof, with an upsettable portion 22, engaging with an axial end portion of the bush of the other wheel element 11.

With the above arrangement, it is possible to assemble the wheel elements 11 to the supporting body 2.

The outer finishing of the wheel elements is performed by front covering elements 30, axially engaging with the outer faces of the wheel elements 11, and being provided with a cylindric end piece 31 engaging in an annular groove 32 defined at the end portions of the bush.

Thus, it is possible to apply to the castor wheel, upon assembling it, a front covering.

Said front covering can be mounted and changed, depending on aesthetic requirements of the user, without using specifically designed application tools.

Thus, the above disclosed arrangement allows to hold in a store assembled castor wheels with a possibility of applying the finishing element, comprising the mentioned front covering, having the required color, depending on the contingent requirements.

From the above disclosure it should be apparent that the invention fully achieves the intended aim and objects.

In particular, it should be apparent that the specifically designed adopted construction, in which the wheel elements are coupled to the supporting body by an upsettable pin, allows to complete the assembling of the castor wheel at a delayed time, without using assembling tools.

In practicing the invention, the used materials, provided that they are compatible to the intended application, as well as the contingent size and shapes, can be any, depending on requirements.

1. An easily assembled castor wheel, specifically designed for chairs, armchairs and the like, comprising a supporting body defining a seat for housing a vertical pin for coupling said castor wheel to a chair, and supporting a pair of adjoining wheel elements, characterized in that said castor wheel comprises front covering means removably coupled to said wheel elements.

2. A castor wheel, according to claim 1, characterized in that said pair of wheel elements are coupled to said supporting body by a pin having, at one end thereof, an enlarged pin head and, at another end portion thereof, an upsettable portion, and that said pin engages with axial end portions of bush elements defined by said wheel elements.

3. A castor wheel, according to claim 1, characterized in that said front covering elements comprise an axial end piece which can be pressure engaged in an annular seat defined by said castor wheel at an axial end of said bush.

4. A castor wheel, according to claim 1, characterized in that said wheel elements comprise an inner tooth pattern which can be engaged with a locking tooth pattern of a pedal element swingably mounted on said supporting body.

5. An easily assembled castor wheel, specifically designed for chairs, armchairs, furniture pieces and the like, according to claim 1, and substantially as broadly disclosed and illustrated and for the intended aim and objects.
